(19) United States
(12) Patent Application Publication
(10) Pub. No.: US 2009/0037206 A1
(43) Pub. Date: Feb. 5, 2009

(54) Method of forecasting maintenance of a machine

(76) Inventors: Brian Dara Byrne, Poway, CA (US); Chad Jerell Anderson, San Diego, CA (US); Charles J. Swiniarski, Poway, CA (US)

Correspondence Address: CATERPILLAR/FINNEGAN, HENDERSON, L.L.P., 901 New York Avenue, NW, WASHINGTON, DC, 20001-4413, US

(21) Appl. No.: 11/882,237

(22) Filed: Jul. 31, 2007

(51) Int. Cl. G06Q 10/00; G06Q 90/00

(52) U.S. Cl. 705/1; 705/28; 705/8

(57) ABSTRACT

A method of forecasting maintenance of a machine is disclosed. The method includes measuring a parameter of the machine, the parameter being indicative of a condition of the machine, and transferring the measured parameter to a maintenance planning system. The method also includes predicting two or more parameter variation curves indicating the variation of the parameter over time, each parameter variation curve representing values of the parameter at a different confidence level. The method further includes identifying a first time period for maintenance of the machine based on the two or more parameter variation curves.

### TECHNICAL FIELD

The present disclosure relates generally to forecasting maintenance, and more particularly to a method of forecasting maintenance of a machine.

### BACKGROUND

A service organization provides maintenance service for machinery through long-term maintenance contracts. These service organizations strive to maintain the machines in good working order at the lowest cost. The client organization that operates these machines also rely on their ability to operate these machines with a minimum of disruption due to machine break downs and/or planned shut downs. The importance of efficient maintenance planning for the service organization becomes all the more important when the machines at a remote location have to be maintained. Currently, maintenance of such machines are performed in an ad-hoc manner. For instance, preventive maintenance is performed at regular intervals based on manufacturer's instructions, or based on the service organization's experience.

The service needs of many machines are dependent on their operating conditions, and following a manufacturer's suggested maintenance schedule may likely be inefficient. For instance, a gas turbine engine that is stopped and started more frequently may have a different failure rate than a gas turbine engine operating which is operated continuously. Even among machines that are operated similarly, the interaction of many environmental, operational and machine specific factors may cause variations in the failure rate between these machines. Although for complex machines, such as gas turbine engines, manufacturer's suggested maintenance schedules do account for the operational conditions of the machines, they may still over/under predict maintenance in many cases. For a service organization than maintains numerous machines in a contract, these over/under predictions may be costly, an approach that predicts a failure may be needed.

U.S. Pat. No. 6,836,539 (the '539 patent) to Katou et al. describes a machine maintenance management method to quickly and accurately repair machines that operate at remote locations under severe conditions. The method of the '539 patent uses an electronic control unit (ECU) attached to the machine to monitor an operating condition of the machine. The monitored operating condition is then transmitted to a monitoring facility. When the monitored operating condition indicates a failure of the machine, the ECU determines the cause of the failure and communicates repair instructions to repair personnel. The method of the '539 patent further includes placing purchase orders for replacement parts to reduce down-time of the machine during repair.

Although the maintenance management method of the '539 patent may reduce the time taken to repair a machine at a remote location, this method only addresses machine repair after a failure has occurred. The method of the '539 patent does not provide for preventive maintenance of the machine to prevent the failure. Additionally, the approach of the '539 patent may not be suitable for a case where the maintenance of many machines are to combined to save repair costs.

The disclosed maintenance forecasting method is directed to overcoming one or more of the problems set forth above.

### SUMMARY OF THE INVENTION

In one aspect, a method of forecasting maintenance of a machine is disclosed. The method includes measuring a parameter of the machine, the parameter being indicative of a condition of the machine, and transferring the measured parameter to a maintenance planning system. The method also includes predicting two or more parameter variation curves indicating the variation of the parameter over time, each parameter variation curve representing values of the parameter at a different confidence level. The method further includes identifying a first time period for maintenance of the machine based on the two or more parameter variation curves.

In another aspect, a method of scheduling maintenance of a group of machines is disclosed. The method includes forecasting two or more failure times for each machine of the group of machines based on a measured parameter of the machine and identifying a time period between the two or more failure times for each machine. The method also includes identifying a second time period as the period of time where the time periods of two or more machines of the group of machines overlap, and scheduling maintenance of the two or more machines during the second time period.

In yet another aspect, a maintenance forecasting system for a group of machines is disclosed. The system includes a sensor located on each machine of the group of machines. The sensor is configured to measure a parameter indicative of a condition of the machine. The system also includes a control system which receives the parameter from each machine of the group of machines. The control system is configured to analyze the parameter and display results. The results include predicted time periods of failure for each machine of the group of machines. The predicted time period is a period of time when failure of the machine may occur. The results also include a recommended maintenance time period. The recommended maintenance time is a period of time when the predicted time periods of two or machines of the group of machines overlap.

### BRIEF DESCRIPTION OF THE DRAWINGS

FIG. 1 is a schematic illustration of an exemplary maintenance forecasting system consistent with certain disclosed embodiments;

FIG. 2 is an illustration of an exemplary result produced by the maintenance forecasting system of FIG. 1; and

FIG. 3 is an illustration of another exemplary result produced by the maintenance forecasting system of FIG. 1.

### DETAILED DESCRIPTION

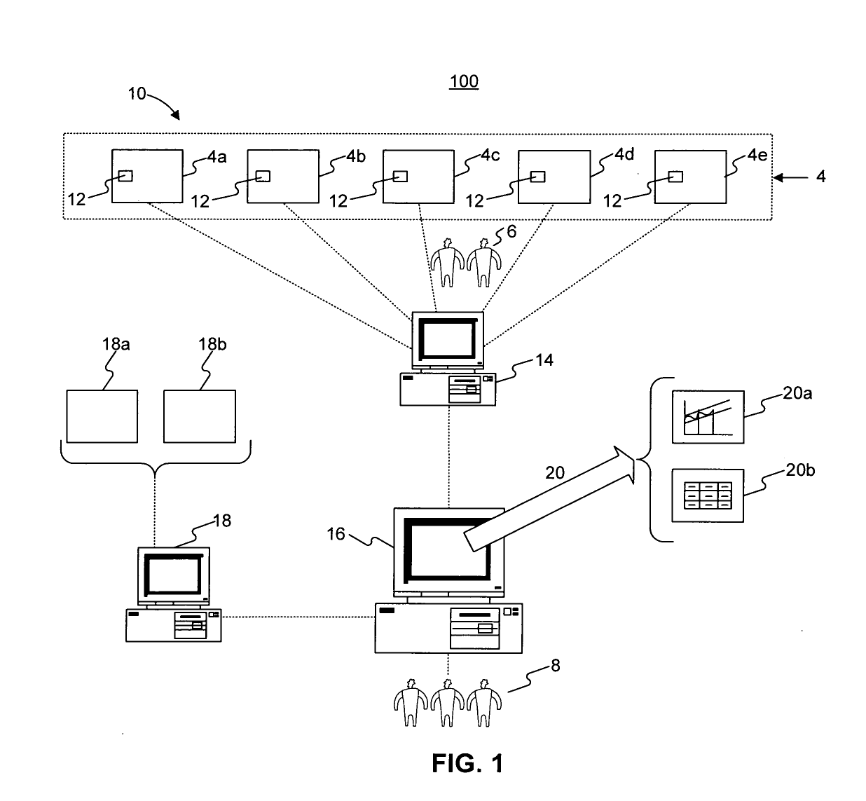

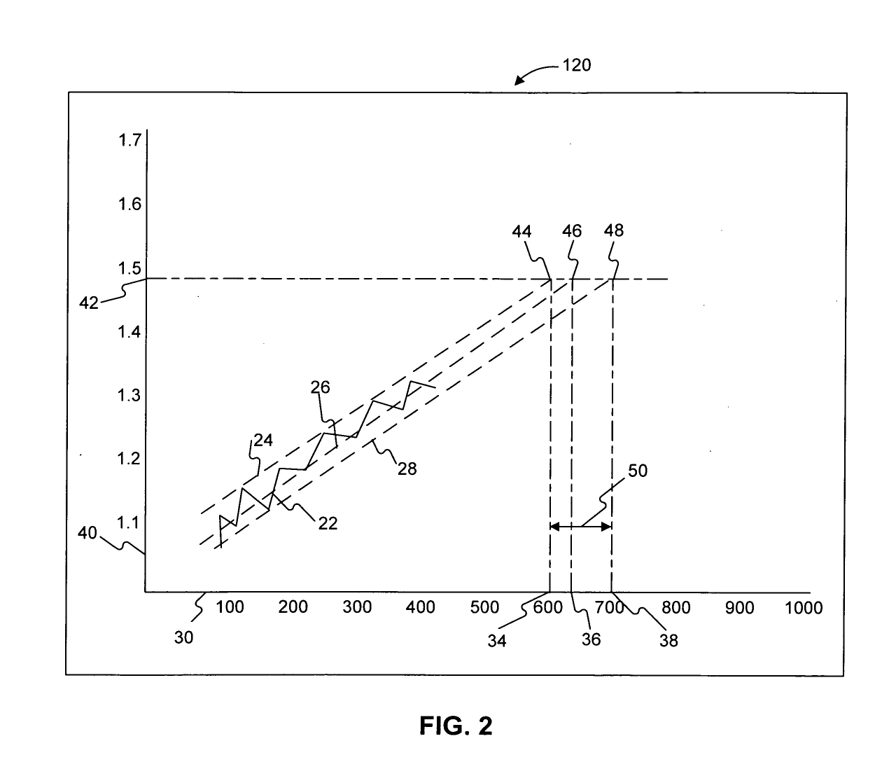

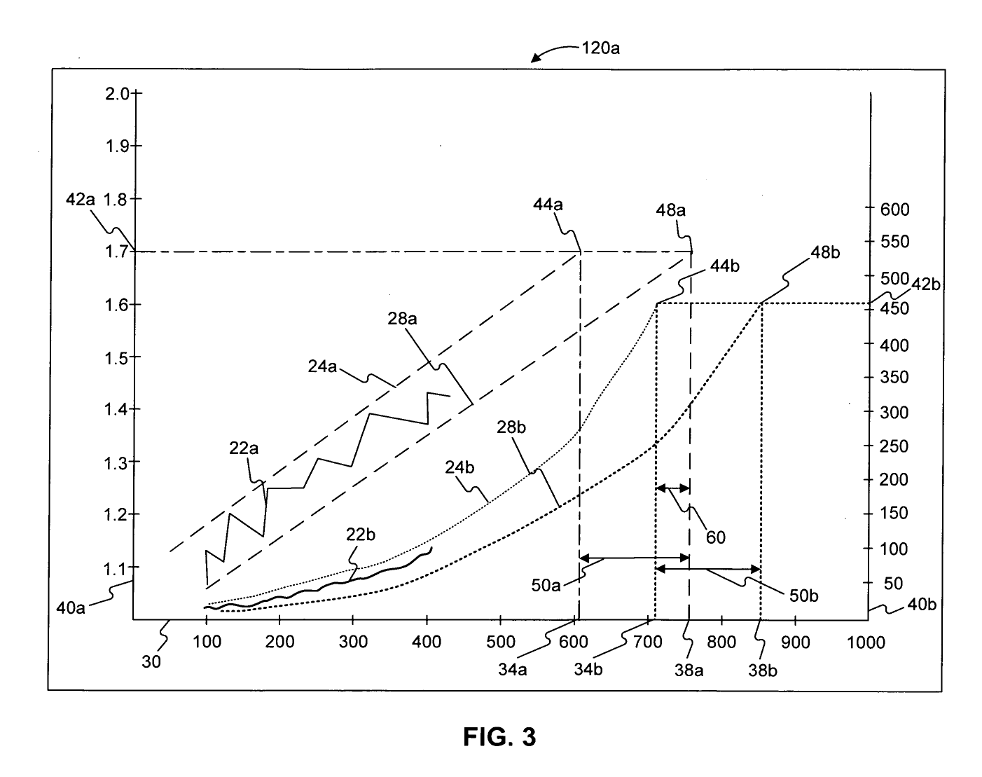

Reference will now be made in detail to exemplary embodiments, which are illustrated in the accompanying drawings. Wherever possible, the same reference numbers will be used throughout the drawings to refer to the same or like parts. In the description that follows, FIG. 1 will be used to describe a system for performing an embodiment of the disclosed maintenance forecasting for a machine, and FIGS. 2 and 3 will be used to provide a general overview of the maintenance forecasting method.

A machine 4, as the term is used herein, may include a fixed or mobile machine that performs some sort of operation associated with a particular industry, such as mining, construction, farming, power generation, etc. Non-limiting examples of a fixed machine may include turbines, power production systems, or engine systems operating in a plant or an off-shore environment. Non-limiting examples of a mobile machine may include trucks, cranes, earth moving vehicles, mining vehicles, backhoes, material handling equipment, marine vessels, aircraft, and any other type of movable machine that operates in a work environment. The term machine 4 may refer to a single machine or a collection of similar or dissimilar individual machines (first machine 4a, second machine 4b, etc.), located at a work site. For example, the term “machine” may refer to a single fork-lift truck in a plant, a fleet of mining vehicles at a mine-site in Australia, a collection of gas turbine engines at an oil-field, or to a group encompassing fork-lift trucks, haul vehicles, and other earth moving equipment at a construction site.

The location where machine 4 operates will be referred to as a work site 10. A person who operates machine 4 will be referred to as a machine user 6. Machine user 6 may include an individual, group or a company that operates machine 4. A service technician 8 may include personnel of a company or a group assigned the task of maintenance of machine 4 (service contractor), and repair technicians who perform the maintenance. Although service technician 8 and machine user 6 are described as different sets of people, it is contemplated they may, in fact, be the same group of people in embodiments where the personnel of the same company operate and maintain machine 4.

FIG. 1 illustrates a maintenance system 100 for forecasting maintenance of machine 4. Machine 4, in FIG. 1 includes a collection of individual machines (first machine 4a, second machine 4b, third machine 4c, fourth machine 4d, and fifth machine 4e) located at work site 10. As indicated earlier, the individual machines can be the same or different type of machines. In the description that follows, the term “machine” is used to refer to some or all of the machines in the collection of individual machines. Machine 4 may include one or more sensors 12 that measure some characteristic of machine 4. For instance, sensors 12 may include temperature sensors that detect the temperature at a location of machine 4 and pressure sensors that measure the pressure at a locations of machine 4. Sensors 12 may communicate the measured data of machine 4 to a machine interface module 14. Machine interface module 14 may include a computer system or other data collection system. The communication of the data from sensors 12 to machine interface module 14 may be continuous or periodic, and may be accomplished through a wired connection or a wireless setup. Machine interface module 14 may be portable or fixed, and may be located proximate or remote to machine 4. Machine interface module 14 may collect and compile data from sensors 12 of many different machines 4 at work site 10. Machine interface module 14 may also include storage media to store the data and a display device, such as a monitor, to display the data to machine user 6. In some embodiments, machine interface module 14 may also be configured to perform computations and display the results of these computations to machine user 6. In these embodiments, machine interface module 14 may include software configured to perform the computations.

Machine user 6 may also input data into machine interface module 14. The data inputted by machine user 6 may include data related to a status of machine 4. For instance, the data input by machine user 6 may include data related to the daily operation of machine 4, the maintenance of machine 4, or a defect observed on machine 4. Machine user 6 may electronically input the data (for instance, through an input device), or manually record the data (on one or more log books), which may then be input into machine interface module 14.

Machine interface module 14 may transmit data to a machine monitoring system 16. Machine monitoring system 16 may include a computer system or a plurality of computer systems networked together. It is also contemplated that computers at different locations may be networked together to form machine monitoring system 16. Machine monitoring system 16 may include software configured to perform analysis, a database to store data and results of the analysis, a display device and/or an output device configured to output the data and the results to service technician 8. The data transmitted by machine interface module 14 may include data measured by sensors 12 and data recorded by machine user 6. This transmission of data to machine monitoring system 16 may be continuous or periodic, and may be accomplished by any means known in the art. For instance, the data transmission may be accomplished using the word wide web, a wireless communication system, a wired connection, or by transferring a recording medium (flash memory, floppy disk, etc.) between machine interface module 14 and machine monitoring system 16. Machine monitoring system 16 may be located proximate to work site 10 or may be situated in a remote location. Machine monitoring system 16 may be configured to receive data from multiple machine interface modules 14 located at different geographic locations. In some instances, multiple machine interface modules 14 located in different continents may transmit data to machine monitoring system 16 located at one location. For instance, a machine monitoring system 16 located in San Diego, Calif. may receive data transmitted from a machine interface module 14 located at an oil field in the Persian gulf, a coal mine in Australia, and a power generating plant in India.

It is contemplated that in some cases, a separate machine interface module 14 may be eliminated and the sensor data and the machine user data may be input directly into machine monitoring system 16. Machine monitoring system 16 may perform analysis (using a software configured to do the analysis) on the data transmitted by machine interface module 14 along with other data stored in machine monitoring system 16. The analysis may include any logic based operation that produce some results 20. Non-limiting examples of the analysis that may be performed by machine monitoring system 16 may include, comparing the performance of a machine at one site to that at another site, predicting time to failure of machine 4, assigning of probability values to the failure time predictions, suggesting maintenance schedule for machine 4.

Results 20 of these analyses may include forecasted failure times 20a and suggested maintenance schedule 20b for machine 4. Although forecasted failure times 20a and suggested maintenance schedule 20b of result 20 are depicted in FIG. 1 as different outputs, they may in fact be included in a single output. Results 20 may be presented to service technician 8 on the display device and/or as printed reports. Machine monitoring system 16 may also be configured to automatically update logistical planning systems 18, such as, for example, an inventory management system 18a and/or a personnel scheduling system 18b, based on results 20. Machine monitoring system 16 may also periodically update results 20 based on analysis of more recent data transmitted from machine interface module 14. These updated results 20 may include updated forecasted failure times 20a and suggested maintenance schedule 20b. Based on these reassessed predicted failure times, machine monitoring system 16 may update the suggested maintenance schedules and logistical planning systems 18.

Machine monitoring system 16 may also be configured to receive data input from service technician 8 and include this data in results 20. For instance, service technician 8 may receive a production schedule of machine 4 from machine user 6. This production schedule may include information from which time periods of anticipated low use of machine 4 may be extracted. Time periods of anticipated low use may be time periods when machine 4 may be shut down with minimal disruption to operation of work site 10. This data may be input into machine monitoring system 16 by service technician 8. Machine monitoring system 16 may include these time periods of low use to suggest maintenance schedules that may minimize impact to the work site 10.

FIG. 2 illustrates a display of result 20 of machine monitoring system 16. The result 20 may be depicted as a graph 120. Graph 120 may plot a parameter 22 as a function of elapsed time. Parameter 22 may be a value computed by machine monitoring system 16 or data recorded by machine interface module 14. For instance, parameter 22 may be data recorded by sensor 12 on machine 4. Value 40 of parameter 22 may be indicated on the y-axis with elapsed time 30 on the x-axis. Value 40 may be the magnitude of the parameter 22 or may be some comparative indicator of parameter 22. Elapsed time 30 may be any measure of time. For instance, elapsed time 30 may be the operating hours of machine 4. Elapsed time 30 could also be some other measure of time not connected with the operation of machine 4. For instance, in embodiments where graph 120 indicates the variation of parameter 22 by day, the elapsed time 30 plotted on x-axis may be days. In FIG. 2, the values 40 of the illustrated parameter on the y-axis (“1.1,” “1.2,” etc), and the magnitudes of elapsed time 30 on the x-axis (“100,” “200,” etc.), are illustrative only.

Graph 120 may also include curves indicating estimations of failure. Graph 120 depicts three of these estimations, namely a first failure estimation curve 24, a second failure estimation curve 26, and a third failure estimation curve 28. These failure estimations may indicate predictions of the change in plotted parameter 22 with elapsed time 30 with different probabilities. First, second, and third failure estimation curves (24, 26, and 28) may predict the change in parameter 22 with elapsed time 30 with probabilities of 10%, 50%, and 90% respectively. That is, the curve representing first failure estimation curve 24 may indicate with 10% certainty that parameter 22 will change with time (plotted on x-axis) in the indicated manner. Likewise, second and third failure estimation 26, and 28 curves may indicate with 50% and 90% certainty, respectively, that parameter 22 will change with time in the manner indicated by these curves. In some embodiments, first failure estimation curve 24 may indicate that for 10% of machines, parameter 22 may vary with time as predicted by the curve. In these embodiments, second failure estimation curve 26 curve may indicate that for 50% of machines, parameter 22 will vary as predicted by the curve, and third failure indication curve 28 may indicate that for 90% of machines, parameter 22 will change as indicated by this curve.

The curves indicating first, second and third failure estimation curves (24, 26 and 28) may be of any form. In some embodiments, these curves may be predicted based on analytical, empirical, or numerical models. The analytical models may be mathematical models that have a closed form solution. That is, value of parameter 22 may be expressed as an equation with known variables (measured by sensors 12, or constants). These equations may then be used to predict the value of parameter 22 at different values of elapsed time 30. In cases where a closed form solution describing parameter 22 is not available, preexisting data may be the basis for the model to predict system behavior. The preexisting data may include prior data from machine 4 which indicates the variation of parameter 22 over time. Preexisting data may also include data from similar machines at different work sites. These models are called empirical models. The empirical model consists of a function that fits the data. A graph of the function goes through the data points approximately. Thus, although the empirical model may not explain the functioning of a system, such a model may predict behavior where data do not exist. Numerical models are mathematical models that use some sort of numerical time-stepping procedure (finite element, finite difference, etc.) to obtain the system behavior over time.

These analytical, empirical, or numerical models may be obtained from the machine manufacturer, or may be obtained from published literature. In some embodiments, the failure estimation curves (first, second and third failure estimation curves) may be based on experience of the service technician 8. For instance, behavior observed from other work sites and/or earlier service contracts may guide selection of the failure estimation curves. These failure estimation curves may be straight lines or curved. In some embodiments, the user (machine user 4 and/or service technician 8) may select the form of the curve. In these embodiments, the user may select one of many available model options to be used in predicting the failure estimation curves. In some embodiments, the user may indicate the probability values for the predictions, and machine monitoring system 16 may automatically choose a model. The user may also choose the number of failure estimation curves to be plotted. For instance, in some embodiments, only one failure estimation curve with a user specified confidence may be plotted. In some embodiments with multiple failure estimation curves, different curves may be based on different models.

Graph 120 may also indicate a threshold value 42 of parameter 22 on the y-axis 40. The threshold value 42 may be a value of parameter 22 that may cause a failure of machine 4. Threshold value 42 may be a manufacturer indicated value or may be based on the prior experience of service technician 8. Any type of failure of machine 4 may be indicated by threshold value 42. For instance, in an embodiment where parameter 22 may be a pressure differential (difference in pressure) across a filter element of machine 4, threshold value 42 may be a value of the pressure differential which may indicate an unacceptably clogged filter. In this case, the failure of machine 4 indicated by threshold value 42 may be the failure of the filter.

The point where first, second, and third failure estimation curves 24, 26, and 28 have a y-coordinate value equal to the threshold value 42, may be the first, second, and third failure point 44, 46, and 48 respectively. That is, first failure point 44, second failure point 46, and third failure point 48, may each have threshold value 42 as their y-coordinate value. The x-coordinate value of first failure point 44, second failure point 46, and third failure point 48 may be the first failure time 34, the second failure time 36, and the third failure time 38, respectively. First failure time 34 may indicate, with 10% probability, the time by which failure of machine 4 may occur. Similarly, second failure time 36, and third failure time 38 may indicate, with 50% and 90% probabilities, respectively, the times by which failure of machine 4 may occur. These predicted failure times of graph 120 may correspond to the forecasted failure times 20a indicated in FIG. 1.

Graph 120 may also indicate the failure interval 50. Failure interval 50 may indicate the period of time at which there is a high likelihood of machine failure to occur. Failure interval 50 may be a time window at which preventive maintenance of machine 4 may be performed without undue risk of failure. In some embodiments, failure interval 50 may be a time period between the first failure time 34 and the third failure time 38. In an embodiment, where a user chooses to plot two failure estimation curves with 25% and 75% failure probabilities, failure interval 50 may indicate the time period between the times at which these two failure estimation curves attain a y-coordinate value corresponding to threshold value 42. It is contemplated that failure interval 50 may be computed by other means. For instance, in some embodiments, failure interval 50 may be a period of time after the occurrence of an event, such a fixed period of time after a sensor indicates a parameter value.

First, second, and third failure estimation curves (24, 26, 28), first, second, and third failure points (44, 46, 48), first, second, and third failure times (34, 36, 38), and failure interval 50 may be updated periodically. They may be updated as more recent parameter 22 values are received or computed by machine monitoring system 16, and plotted on graph 120.

In some embodiments, failure intervals of multiple individual machines (first machine 4a, second machine 4b, third machine 4c, etc.) of machine 4 may be plotted on a graph to indicate a suitable time window at which preventive maintenance of multiple machines may be performed at the same time. FIG. 3 indicates a graph 120a showing the failure intervals of two individual machines, a first machine 4a, and a second machine 4b. Graph 120a plots a first parameter 22a corresponding to machine 4a and a second parameter 22b corresponding to machine 4b as a function of elapsed time 30 of the machines. Elapsed time 30 may be a cumulative time of operation of a machine, and may be plotted on the x-axis of graph 120a. In graph 120a, the y-coordinate values of first parameter 22a may be plotted on a first y-axis 40a, and the coordinate values of second parameter 22b may be plotted on a second y-axis 40b.

First failure estimation curve 24a and second failure estimation curve 28a may be predictions of the change of first parameter 22a with a 10% and 90% probability. Likewise, third failure estimation curve 24b and fourth failure estimation curve 28b may be predictions of the change of second parameter 22b with a 10% and 90% probability. A first threshold value 42a may be a value of first parameter 22a that may indicate a failure of machine 4a, and second threshold value 42b may be a value of second parameter 22b that may indicate a failure of machine 4b. First and second failure points 44a and 48a may be points on first failure estimation curve 24a and second failure estimation curve 24b, respectively, at which first parameter 22a reaches first threshold value 42a. Likewise, third and fourth failure points 44b and 48b may be points on third failure estimation curve 24b and fourth failure estimation curve 28b, respectively, at which second parameter 22b reaches the second threshold value 42b. First failure time 34a and second failure time 38a may be the x-coordinate values of first failure point 44a and second failure point 48a, respectively. First failure time 34a and second failure time 38a may indicate, with 10% probability and 90% probability, respectively, the machine operation time by which failure of machine 4a may occur. Similarly, third failure time 34b and fourth failure time 38b may indicate with 10% probability and 90% probability, respectively, the time by which failure of machine 4b may occur.

First failure interval 50a may be time period between the first and second failure times (34a and 38a), and may indicate a time window at which preventive maintenance of machine 4a may be performed. Similarly, second failure interval 50b may be a time period between the third and fourth failure times (34b and 38b), and may indicate a time window at which preventive maintenance of machine 4b may be performed. The overlap time 60 may be a period of overlap between first failure interval 50a and second failure interval 50b. Overlap time 60 may be a time period at which preventive maintenance of both machines 4a and 4b may be performed without unacceptable risk of premature failure of either machine. Overlap time 60 may correspond to the suggested maintenance schedule 20b indicated in FIG. 1.

Although FIG. 3 illustrates determining an overlap time based on two machines, it is understood that overlap time may be determined based on any number of machines. In some embodiments, overlap time 60 may be based on a similar failure of multiple individual machines. For instance, overlap time 60 may be a common time period for filter replacement of the multiple individual machines. Based on this overlap time 60, service technicians 8 skilled in filter replacement may be dispatched to work site 10 to perform filter replacement on these machines. In other embodiments, overlap time 60 may defined differently. In all cases, overlap time 60 may be a time period where maintenance of multiple machines may be carried out. Based on overlap time 60, maintenance of machine 4 may be scheduled on logistical planning systems 18.

In some embodiments, maintenance monitoring system 16, in addition to determining a suitable time for performing preventive maintenance of machine 4, may also be configured to detect an abnormal behavior of machine 4. In these embodiments, an unacceptable deviation of the monitored parameter (for instance, first parameter 22a and second parameter 22b of FIG. 3) may be flagged as an abnormal condition. Unacceptable deviation may be defined differently for different monitored parameters and applications. In general, any deviation of the monitored parameter which is more likely a result of a malfunction of machine 4 may be an unacceptable variation. In some applications, unacceptable variation may be preset value of deviation, in other application, it may be determined based on a rate of change of the monitored parameter. For instance, maintenance monitoring system 16 may flag a sharp change in the monitored parameter as an unacceptable variation. Depending upon the seriousness of the abnormal behavior, repair of machine 4 may be scheduled.

### INDUSTRIAL APPLICABILITY

The disclosed embodiments related to a maintenance system for forecasting maintenance of machines. The system may be used to schedule maintenance of the machines with a view to maintain reliability of the machines while reducing machine down time and maintenance expenses. Data from the machines and machine users may be used to predict time of failure of the machine with different probabilities. These predicted failure times of different machines may then be used to determine a suitable time when maintenance of a number of machines may be carried out at the same time. Maintenance of multiple machines at the same time may reduce the expenses involved in the maintenance operation. To illustrate the operation of the maintenance system, an exemplary embodiment will now be described.

Multiple gas turbine engines (first machine 4a, second machine 4b, third machine 4c, etc. of FIG. 1) may be located at a power plant in Australia (work site 10). A service company, located in San Diego, Calif., may be responsible for maintaining these gas turbine engines. Pressure sensors (sensors 12) may be located upstream and downstream of a filter of the gas turbine engines. These pressure sensors may measure the pressure differential across the filter. The pressure differential data for each gas turbine engine may be recorded once every hour by an operator. These pressure differential data may then be input into a computer (machine interface module 14) located in the power plant. The computer may transmit the data to a networked computer (machine monitoring system 16) located at the service company once a day.

A service technician 8 may operate the networked computer and plot the pressure differential for each gas turbine engine as a function of the elapsed time of these gas turbine engines in a graph (as in FIG. 2). These plots may indicate how the pressure differential across the filter changes for each gas turbine engine at work site 10. A pressure differential close to “1” may indicate that pressure at the upstream sensor location is close to that at the downstream sensor location. Such a condition may reflect a relatively clean filter. Increasing values of the pressure differential may indicate that the pressure at the upstream filter location may be higher than that at the downstream filter location, indicating that the filter element is clogged and impeding flow through it. Software on the networked computer may predict how the pressure differential of each gas turbine engine may increase over time. The software may make these predictions using empirical models based on previous pressure differential data from gas turbine engines. These predictions may be made at different confidence levels, for example, for 10% and 90% confidence levels. The 90% confidence level prediction may be a conservative estimate of filter clogging based on previous data. These predicted values may also be plotted on the graph along with the recorded pressure differential data.

Based on prior experience, the service technician 8 may know that a value higher than about “1.7” for the pressure differential may be an unacceptably high value that may impact the performance of the gas turbine engine. Therefore, the service technician 8 may decide to perform filter maintenance for the gas turbine engines before the pressure differential across the filter reaches “1.7.” The predicted pressure differential curves in the graph may indicate, with different confidence levels, the time period when the pressure differential may reach “1.7.” The service technician may consider a time period between the two predictions (10% and 90% predictions) to be a suitable time for filter maintenance of a gas turbine engine to be performed. The graph may also identify a period of overlap of these time periods for different gas turbine engines. This period of overlap may be a time period when filter maintenance of a number of gas turbine engines may be performed at the same time. The networked computer may then schedule filter maintenance for the gas turbine engines at the identified period of overlap.

Since maintenance using the disclosed approach is performed before failure actually occurs, the maintenance event may be planned ahead of time. Advance notice of maintenance events may minimize the impact of machine downtime to the machine user. Also, since maintenance events are planned in advance, the downtime may be planned to coincide with other planned machine downtime (for instance, other plant maintenance times, holidays, seasonal slow-down, etc.) to further reduce the impact to the machine user. Additionally, since the maintenance system schedules a maintenance event at a time when multiple machines may be repaired, a service technician who travels to a work site to perform the maintenance may perform multiple machine repairs in one trip, thereby saving time and money.

It will be apparent to those skilled in the art that various modifications and variations can be made to the disclosed method of forecasting maintenance of a machine. Other embodiments will be apparent to those skilled in the art from consideration of the specification and practice of the disclosed maintenance forecasting method. It is intended that the specification and description be considered as exemplary only, with a true scope being indicated by the following claims and their equivalents.

What is claimed is:

1. A method of forecasting maintenance of a machine, comprising:
measuring a parameter of the machine, the parameter being indicative of a condition of the machine;
transferring the measured parameter to a maintenance planning system;
predicting two or more parameter variation curves indicating the variation of the parameter over time, each parameter variation curve representing values of the parameter at a different confidence level; and
identifying a first time period for maintenance of the machine based on the two or more parameter variation curves.

2. The method of claim 1, wherein the first time period is a period of time from when one parameter variation curve reaches a threshold value to when another parameter variation curve reaches the threshold value, the threshold value being a value of the parameter indicative of a condition requiring maintenance of the machine.

3. The method of claim 2, further including performing maintenance of the machine during the first time period.

4. The method of claim 1, wherein the machine includes a plurality of machines located at a work site and the first time period is a period of time when at least one parameter variation curve of each machine of the plurality of machines is equal to or above a threshold value of the parameter, the threshold value being a value of the parameter indicative of a condition requiring maintenance of the machine.

5. The method of claim 1, further including;
measuring a second parameter of a second machine, the second parameter being indicative of a condition of the second machine;
predicting two or more second parameter variation curves indicating the variation of the second parameter over time, each second parameter variation curve representing values of the second parameter at a different confidence level;
identifying a second time period based on the two or more second parameter variation curves; and
identifying an overlapping time period, the overlapping time period being a period of time where both the first time period and the second time period overlap.

6. The method of claim 5, wherein;
the first time period is the period of time from when one parameter variation curve reaches a threshold value to when another parameter variation curve reaches the threshold value, the threshold value being a value of the parameter indicative of a condition requiring maintenance of the machine; and
the second time period is the period of time from when one second parameter variation curve reaches a second threshold value to when another second parameter variation curve reaches the second threshold value, the second threshold value being a value of the second parameter indicative of a condition requiring maintenance of the second machine.

7. The method of claim 6, further including performing maintenance of both machines during the overlapping time period.

8. The method of claim 1, wherein the parameter is measured using one or more sensors located on the machine.

9. The method of claim 1, wherein predicting two or more parameter variation curves includes predicting the parameter variation curves using at least one of analytical models, empirical models, or numerical models.

10. The method of claim 1, wherein transferring the measured parameter includes transferring the measured parameter to a remotely located maintenance planning system.

11. The method of claim 1, further including scheduling the maintenance of the machine in logistical planning systems, the logistical planning systems including one or more of an inventory management system or a personnel management system.

12. The method of claim 1, further including periodically updating the two or more parameter variation curves based on an updated value of the measured parameter.

13. The method of claim 12, further including periodically updating the first time period based on the updated two or more parameter variation curves.

14. A method of scheduling maintenance of a group of machines, comprising:
forecasting two or more failure times for each machine of the group of machines based on a measured parameter of the machine;
identifying a time period between the two or more failure times for each machine;
identifying a second time period as the period of time where the time periods of two or more machines of the group of machines overlap;
scheduling maintenance of the two or more machines during the second time period.

15. The method of claim 14, wherein forecasting two or more failure times includes determining the two or more failure time based on preexisting data.

16. The method of claim 14, wherein forecasting two or more failure times for each machine includes determining two or more times when failure of the machine are likely to occur based on probability.

17. The method of claim 14, wherein scheduling maintenance includes scheduling the maintenance in an inventory management system and a personnel management system.

18. A maintenance forecasting system for a group of machines comprising;
a sensor located on each machine of the group of machines, the sensor being configured to measure a parameter indicative of a condition of the machine;
a control system receiving the parameter from each machine of the group of machines, the control system being configured to analyze the parameter and display results, the results including,
predicted time periods of failure for each machine of the group of machines, the predicted time period being a period of time when failure of the machine may occur; and
a recommended maintenance time period, the recommended maintenance time period being a period of time when the predicted time periods of two or machines of the group of machines overlap.

19. The maintenance forecasting system of claim 18, wherein the parameter is transferred wirelessly to the control system and the control system is located remote from the group of machines.

20. The maintenance forecasting system of claim 18, wherein the group of machines includes a group of gas turbine engines.
